(19) United States
(12) Patent Application Publication
(10) Pub. No.: US 2025/0190354 A1
(43) Pub. Date: Jun. 12, 2025

(54) COMPONENT CACHE USING SEMANTIC LOOK UP IN GENERATIVE ARTIFICIAL INTELLIGENCE SYSTEMS

(71) Applicant: Microsoft Technology Licensing, LLC, Redmond, WA (US)

(72) Inventors: Alexander Christian HALE, Montreal (CA); James Arthur VUCKOVIC, Toronto (CA); Luiz Felipe BELUSSI, Montreal (CA)

(21) Appl. No.: 18/533,825

(22) Filed: Dec. 8, 2023

(51) Int. Cl. G06F 12/0877; G06F 16/2455

(52) U.S. Cl. CPC G06F 12/0877; G06F 16/24552; G06F 2212/60

(57) ABSTRACT

A generative artificial intelligence (AI) system has a plurality of different AI models. A prompt is provided to each of the different AI models and each of the different AI models generates an output. The outputs from the AI models are provided to an orchestrator. The orchestrator selects from among the different model outputs to generate a response. A cache system generates a cache entry, corresponding to the query, for each of the model outputs. When a subsequent query is received, the cache is searched based upon the subsequent query to determine whether any matching cache entries are found. The individual model outputs corresponding to a matching cache entry are output to the individual AI models for validation.

### BACKGROUND

Computing systems are currently in wide use. Many computing systems include hosted services or applications or other types of computing systems.

Some such computing systems are generative artificial intelligence (AI) systems. Such systems receive, as an input, a query or prompt and generate, as an output, a response to that prompt. There may be a wide variety of different types of generative AI systems that perform different generative functions. Such systems may be conversational (or chat) systems, image generation systems, question answering systems, or any of a wide variety of other generative AI systems. In such systems, there may be multiple different AI models to perform the different generative AI functions.

There are a wide variety of different types of generative AI models, which may include large language models (or LLMs). An LLM is a language model that includes a large number of parameters (often in the tens of billions or hundreds of billions of parameters). In operation an LLM receives a prompt, generates tokens based on the prompt, and generates an output or response. The prompt may include data and instructions to generate a particular output. For instance, a generative AI model may be provided with a prompt that includes an instruction (such as to generate a particular type of output—e.g., a summary of a document, a response to a question, etc.) along with examples of that type of output and/or any additional context information. The LLM then begins predicting tokens (representations of words or linguistic units) to build up the output (e.g., the summary, the response to the question, etc.). In another example, the generative AI model may be prompted to generate an image, and the prompt may include a verbal description of the image. Other types of AI models perform classification. For such models, a prompt may be generated which contains data that is to be classified into one or more of a plurality of different categories. The AI model generates an output identifying the classification for the input. These are examples of the different types of AI models that can be used as part of an AI system.

The discussion above is merely provided for general background information and is not intended to be used as an aid in determining the scope of the claimed subject matter.

### SUMMARY

A generative artificial intelligence (AI) system has a plurality of different AI models. A prompt is provided to each of the different AI models and each of the different AI models generates an output. The outputs from the AI models are provided to an orchestrator. The orchestrator selects from among the different model outputs to generate a response. A cache system generates a cache entry, corresponding to the query, for each of the model outputs. When a subsequent query is received, the cache is searched based upon the subsequent query to determine whether any matching cache entries are found. The individual model outputs corresponding to a matching cache entry are output to the individual AI models for validation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIGS. 2A and 2B (collectively referred to herein as FIG. 2) show a flow diagram illustrating one example of the operation of a cache system.

FIG. 3 is a flow diagram showing one example of generating cache entries for the cache system.

FIG. 4 is a block diagram showing one example of the computing system architecture illustrated in FIG. 1, deployed in a remote server architecture.

FIGS. 5-7 show examples of user devices that can be used in various systems, architectures, and devices.

FIG. 8 is a block diagram of a computing environment that can be used in the systems, architectures and devices illustrated in previous figures.

### DETAILED DESCRIPTION

As discussed above, generative artificial intelligence (AI) systems are often composed of many different generating components that are managed by an orchestrator. Each component may be an AI model. For example, a language generation system may have one component which generates conversational text, another component which answers factual questions, and a third component which creates images. The orchestrator is responsible for determining which component outputs to include in the final output.

A cache is a mechanism that stores data such that future requests for that data can be served faster or with less computational expense. Each entry in the cache has a key that uniquely identifies the entry. The key is also used to look up entries in the cache to see if one of the entries can be used for a subsequent request. In many cache systems, a look up operation is done using an exact match in that the exact key being searched must exist in the cache to be a successful look up.

Such cache systems have a number of drawbacks when applied to generative AI systems. For instance, in a generative AI system, such a cache system would normally store only the final output from the orchestrator. Therefore, if any of the individual component outputs are changed (such as due to expiration, an AI model upgrade, or for some other reason), then the cache entry cannot be used to serve a subsequent query and, instead, all of the individual AI components must be re-run on the subsequent query to compute a final output. This incurs a large graphics processing unit (GPU) expense and takes longer for the AI system to respond to the query (e.g., the prompt).

Therefore, in one example, the present description describes a system in which, for a given prompt (or query), the output of each of the individual AI models is cached. Then, when a matching subsequent query is received, all the cached model outputs for the query are output to the individual models for validation. If a model output is validated, that model output is provided to the orchestrator without re-running the corresponding AI model. If a model output is not valid, then only the corresponding AI model is re-run on the query to generate a valid model output which is provided to the orchestrator, instead of re-running all of the AI models on the query.

This can add some additional storage cost because there may be many more individual outputs from the AI models (or content-generating components) in an AI system which are cached compared to a single final response. Also, some central processing unit (CPU) cost may be incurred as the orchestrator must run, even after a cache hit to assemble the final output from the individual, cached, component outputs. However, the savings in GPU resources gained by being able to individually refresh the AI model outputs (as opposed to running all of the models) is much more significant than the additional storage and CPU costs. Further, the system is much more flexible in that AI components or models can be added and removed at any time, and multiple versions of a component can be stored to allow for gradual upgrades from one version of a component to the next version.

A second drawback that is encountered when using a cache system for caching data in an AI system involves the exact match-type look up operation used in normal cache systems. Such a look up or search operation is very strict for conventional AI systems and thus generates problems. For instance, in a normal cache system, a prompt or query submitted to the AI system is used as a key to the cache entry. Therefore, when a subsequent query is received, the keys to the cache entries can be searched to determine whether any of the keys match the subsequent query, exactly, to see whether a matching cache entry already exists. However, particularly with generative AI systems, the prompt or query for an item of information can take a wide variety of different forms, but have a similar semantic meaning. For instance, a query to an AI system may be “How tall is the ABC tower?” Such a query is nearly identical in meaning to “ABC tower height”. Creating separate cache entries for those two queries is a waste of computational resources and storage space.

Thus, in one example, the present description describes a system which performs semantic look up when searching for cache entries. A semantic representation of a query or prompt, that represents the meaning of the query or prompt, is generated and that semantic representation is used as the key to a cache entry for that particular query or prompt. Then, when a subsequent query or prompt is received, a semantic representation of the subsequent query or prompt is also generated and that semantic representation is used to perform a look up operation against the semantic keys to the cache entries in the cache system.

In one example, a semantic encoder generates the semantic representation of the queries as a query vector, and a search algorithm identifies the closest cache entry by identifying a distance, in vector space, between the semantic representation of the current query and the semantic key value for the cache entry. The distance between the semantic representation of the current query and the closest cache entry is compared to a threshold distance to determine whether the closest cache entry can be considered a match. This reduces the storage required to store cache entries and greatly reduces the search space, while still ensuring that semantically similar queries are matched.

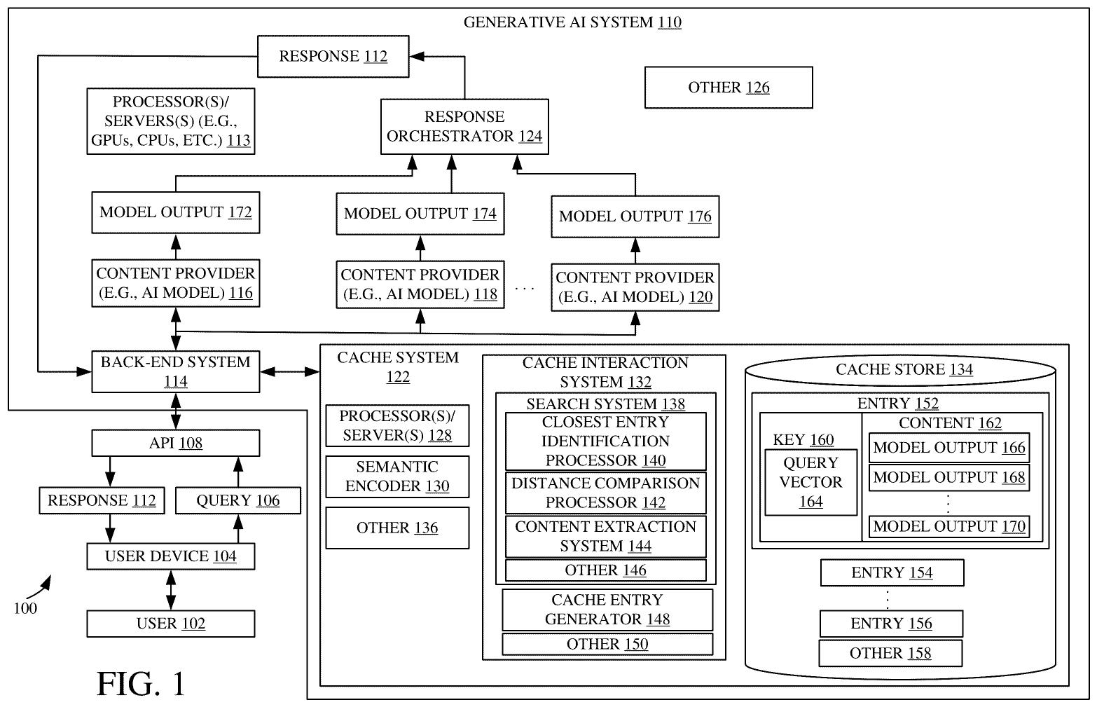

FIG. 1 is a block diagram of one example of a computing system architecture 100 in which a user 102 can use a user device 104 to generate a query 106 (through an exposed appl programming interface—API—108) to a generative AI system 110. The generative AI system 110 can generate a response 112 to the query 106, and the response 112 can be provided back through API 108 to user device 104 where it can be accessed by user 102.

In the example shown in FIG. 1, generative AI system 110 includes one or more processors or servers (such as GPUs, CPUs, etc.) 113, and a back-end system 114 which exposes API 108 for interaction with user device 104. Generative AI system 110 also includes a plurality of content providers 116, 118, and 120, which may each be a different type of generative AI model, or other component. Generative AI system 110 also includes cache system 122, orchestrator 124, and it can include a wide variety of other functionality 126.

Cache system 122, itself, can include one or more processors or servers 128, a semantic encoder 130, cache interaction system 132, cache store 134, and other items 136. Cache interaction system 132 can include search system 138 (which, itself, can include closest entry identification processor 140, distance comparison processor 142, content extraction system 144, and other items 146), cache entry generator 148, and other items 150. In the example shown in FIG. 1, cache store 134 includes a plurality of different cache entries 152, 154, and 156, and cache store 134 can include other items 158 as well. Each cache entry illustratively includes a key portion 160 and a content portion 162. Key portion 160 includes a semantic representation of a query or prompt (e.g., query vector) 164 (along with the text version of the query) that has been provided to generative AI system 110. Content portion 162 includes model outputs 166, 168, and 170, which were output by content providers (e.g., AI models) 116, 118, and 120, respectively, for the query represented by the semantic representation (e.g., query vector) 164. Before describing the overall operation of generative AI system 110 in more detail, a description of some of the items in generative AI system 110, and their operation, will first be provided.

Back-end system 114 can expose API 108 for interaction by user devices 104. Back-end system 114 can also interact with cache system 122 to determine whether there are any cache entries in cache store 134 that may satisfy a newly received query 106. Further, back-end system 114 can provide the content 162 from any matching cache entries to the corresponding content providers 116, 118, and 120. The content providers 116, 118, and 120 may be different types of generative AI models, such as conversational models, question answering models, image generation models, etc. Each of the content providers 116, 118, and 120, provide a model output 172, 174, and 176, respectively, in response to queries received from back-end system 114. Response orchestrator 124 may, itself, be an AI component or another component. The response orchestrator 124 receives the model outputs 172, 174, and 176 from the respective content providers 116, 118, and 120, and chooses which of those model outputs 172, 174, and 176 should be included in response 112. Response orchestrator 124 then provides response 112 back to back-end system 114 where response 112 can be returned through API 108 to the user device 104.

In using cache system 122, when back-end system 114 receives a query 106, that query may be provided by back-end system 114 to cache system 122. Semantic encoder 130 generates a semantic representation of the query 106 and provides that semantic representation to cache interaction system 132. In one example, the semantic representation of query 106 is a vector of numerical values. Semantic encoder 130 can, itself, be an AI component, such as a Siamese network or other component that is trained to group queries with similar semantic meanings together in vector space. Thus, semantic encoder 130 generates similar semantic encodings for queries that have similar meanings. The semantic representation or query 106 is provided to cache interaction system 132. Search system 138 can search cache store 134. Closest entry identification processor 140 identifies the distance between the semantic representation of query 106 and the different query vectors 164 in the key portions of each cache entry 152, 154, and 156. Closest entry identification processor 140 then identifies the particular cache entry that has a query vector 164 that is closest, in vector space, to the query vector generated for query 106. Distance comparison processor 142 compares the distance between the query vector generated for query 106 and the query vector for the closest cache entry to determine whether the distance meets a threshold value. For instance, if the distance is below a threshold value, this may indicate that the closest cache entry is a match for query 106. Assume for the sake of discussion that cache entry 152 is the closest cache entry and the distance between the semantic query vector generated for query 106 and query vector 164 is below the threshold value. This means that the cache entry 152 is a matching cache entry (e.g., a “cache hit”). When such a match is identified, content extraction system 144 extracts the content 162 (the model outputs 166, 168, and 170) from the matching cache entry 152 and returns the extracted content to back-end system 114 where back-end system 114 can provide the model outputs 166, 168, and 170 to the content provider 116, 118, and 120 which generated those model outputs. Each of the content providers 116, 118, and 120 can then determine whether its model output is still valid. For instance, the model output may have expired, or it may be invalid because it was generated by a different version of the content provider, or it may be invalid for any of a wide variety of other reasons. For each model output from a content provider that is valid, that content provider can simply provide the cached model output as its model output for the current query 106. For instance, if model output 166 was previously provided by content provider 116 and it is still valid, then content provider 116 can simply pass model output 166 to response orchestrator 124 as its response to query 106 and the content provider (e.g., AI model) 116 need not be re-run for the current query 106. The same can be performed at each of the other content providers 118, and 120.

However, if, for instance, model output 166 is determined by content provider 116 to be invalid, because it has expired, then content provider 116 (e.g., the AI model) can be re-run for query 106 to generate a new, valid, model output 172 that can be provided to response orchestrator 124.

It can thus be seen that each of the individual content providers 116, 118, and 120 has an individual model output that is cached in a cache entry. Thus, when the cache entry is matched for a subsequent query, only the model outputs from the cache entry that have expired or are invalid for some other reason need to be regenerated by the corresponding content provider 116, 118, and 120. By contrast, in prior systems, since only the response 112 was cached, if any of the model outputs in the response 112 were invalid, then all of the content providers 116, 118, and 120 would need to be re-run to generate a new response 112. Thus, caching the output of each of the content providers significantly reduces computational expense. Further, because search system 138 searches the cache entries based upon a semantic representation of the query, two different queries that have the same or similar semantic meaning can be identified as matching. This significantly enhances the operation of cache system 122 over prior systems where exact matches were needed to identify a matching cache entry.

Returning again to the operation of cache system 122, assume that search system 138 did not identify a matching cache entry for query 106. In that case, cache entry generator 148 generates a cache entry for query 106 once the model outputs 172, 174, and 176 are generated for query 106 by the individual content providers 116, 118, and 120, respectively. Cache entry generator 148 generates a cache entry using the semantic representation of query 106 (e.g., the query vector generated for query 106) as the key and the model outputs 172, 174, and 176 as the content of the cache entry for query 106. The query 106, itself, is also stored along side the query vector for query 106. In one example, the textual query 106 is not used as a key to perform look-ups but may be stored for other reasons as discussed below.

Generating cache entries in this way provides significant advantages as well. For instance, where a new content provider is added to generative AI system 110, cache entry generator 148 can populate cache store 134 with the model outputs of the new content provider by simply running the new content provider against a series of queries that are already represented by the different cache entries 152-156, and add the model output to the content portion 162 of the corresponding cache entries. For instance, if a new content provider is added to generative AI system 110, then cache entry generator 148 can extract the textual query that is stored along side the query vector 164 from cache entry 152 and provide it to back-end system 114 which provides the textual query to the new content provider to obtain a model output from the new content provider. The new model output can be added as a model output in content portion 162 in cache entry 152 so that the cache entry 152 now includes a model output from all of the content providers (including the newly added content provider) in generative AI system 110.

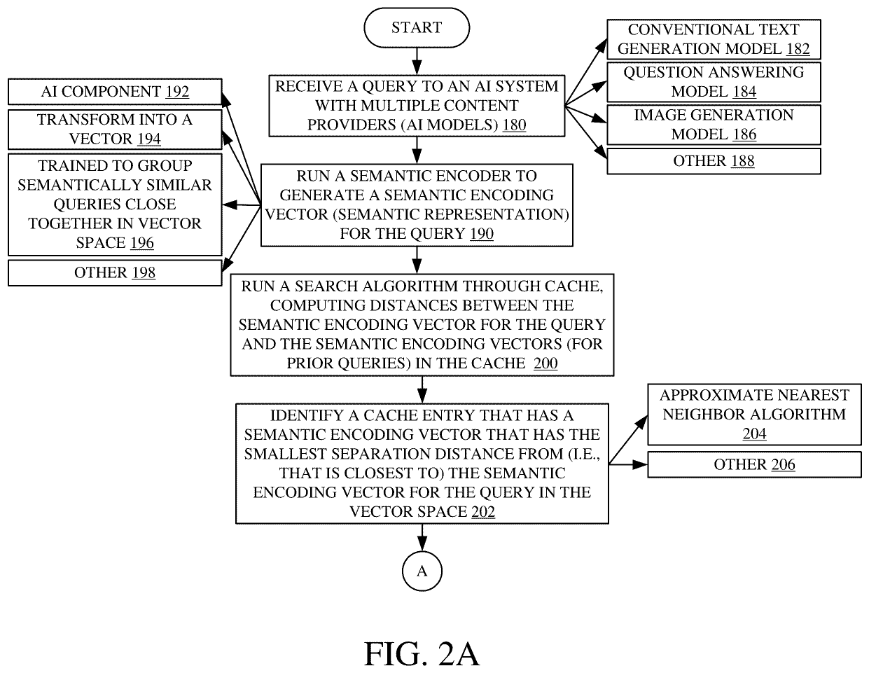

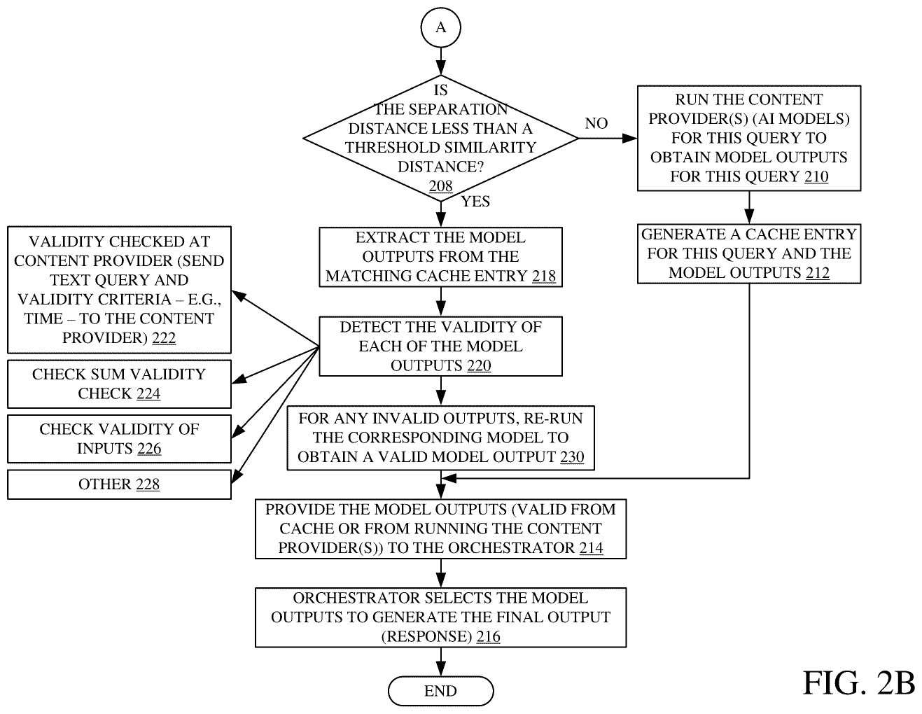

FIGS. 2A and 2B (collectively referred to herein as FIG. 2) show a flow diagram illustrating one example of the operation of generative AI system 110 in utilizing cache system 122. It is first assumed that a query 106 is received by generative AI system 110 that has multiple content providers (e.g., AI models) 116-120. Receiving a query is indicated by block 180 in the flow diagram of FIG. 2. The content providers can include such things as a conversational text generation model 182, a question answering model 184, an image generation model 186, and/or any of a wide variety of other AI models 188.

Back-end system 114 provides query 106 to semantic encoder 130 which generates a semantic encoding vector (e.g., a semantic representation) corresponding to query 106, as indicated by block 190 in the flow diagram of FIG. 2. The semantic encoder 130 may, itself, be an AI component 192. The semantic encoder 130 may transform query 106 into a numerical vector as indicated by block 194. The semantic encoder 130 may be trained to group semantically similar queries close to one another in vector space, as indicated by block 196. The semantic encoder may be any of a wide variety of other semantic encoders and operate in other ways, as indicated by block 198.

Search system 138 then runs a search algorithm, searching cache store 134 for a matching cache entry. Closest entry identification processor 140 runs a search algorithm through the cache store 134 computing distances between the semantic encoding vector generated for the query 106 and the semantic encoding vectors for prior queries, stored as keys in the cache entries in cache 134. Running such a search algorithm, computing the distances, is indicated by block 200 in the flow diagram of FIG. 2.

Closest entry identification processor 140 identifies a cache entry that has a semantic encoding vector (or query vector 164) that has the smallest separation distance from (i.e., that is closest to) the semantic encoding vector for the query 106. Identifying the entry in cache store 134 that is closest in vector space to the query 106, is indicated by block 202 in the flow diagram of FIG. 2.

In one example, the closest entry identification processor 140 runs an approximate nearest neighbor algorithm that identifies the approximate nearest neighbor, in vector space, to the query vector generated for query 106. Running an approximate nearest neighbor algorithm is indicated by block 204 in the flow diagram of FIG. 2. The search algorithm can be a different search algorithm or run in other ways as well, as indicated by block 206.

Distance comparison processor 142 then determines whether the separation distance between the query vector for query 106 and the query vector in the closest cache entry is less than a threshold similarity distance, as determined at block 208 in the flow diagram of FIG. 2. The threshold similarity distance may be a value that is set to indicate that query 106 is semantically similar enough to the query that produced the matching query entry in cache store 134 that the two should be considered a match. The threshold similarity distance may be set empirically. The threshold similarity distance may be a default value, a dynamically variable value, or another value determined in another way.

If distance comparison processor 142 determines that the separation distance between the query vector for query 106 and the query vector in the closest cache entry is not less than the threshold similarity distance, then that means that there is no matching cache entry for query 106, and the query 106 is provided by back-end system 114 to the content providers 116, 118, and 120 so that the content providers (e.g., the AI models) can run on this query 106 to obtain model outputs for this query 106. Running the AI models to generate model outputs for this query 106 is indicated by block 210 in the flow diagram of FIG. 2.

Cache entry generator 148 then generates a cache entry for this query 106 based on the model outputs 172, 174, 176 generated by the content providers 116, 118, 120. Generating a cache entry is indicated by block 212 in the flow diagram of FIG. 2. The model outputs 172, 174, 176 are then provided to response orchestrator 124, as indicated by block 214. Response orchestrator 124 then selects which of the model outputs 172, 174, 176 should be used to generate the final output (for response 112). Running the orchestrator 124 to generate the response 112 is indicated by block 216 in the flow diagram of FIG. 2.

Returning again to block 208, assume now that the separation distance between the query vector of the closest cache entry and the query vector generator for query 106 is less than the threshold similarity distance. This means the closest cache entry is a match for query 106. Again, assume for the sake of discussion that cache entry 152 is the matching cache entry. Content extraction system 144 then extracts the model outputs 166, 168, 170 from the matching cache entry 152, as indicated by block 218 in the flow diagram of FIG. 2. The extracted model outputs 166, 168, and 170 are then provided from back-end system 114 back to the content providers 116, 118, 120, which generated those model outputs. Each of the content providers 116, 118, 120 can then detect whether the model output that it previously generated is still valid. Detecting the validity of each of the model outputs 166, 168, 170 retrieved from cache system 122 is indicated by block 220 in the flow diagram of FIG. 2. Checking the validity of each of the model outputs 166, 168, 170 at the content provider that generated the model outputs 166, 168, 170, is indicated by block 222 in the flow diagram of FIG. 2.

In one example, when the matching cache entry 152 is retrieved, the text representation of the query that was encoded into the query vector 164, and stored along side query vector 164, can be retrieved, or the matching query 106 can be used as the text representation of the query. The text representation of the query, and any validity criteria that may be used by the different content providers, are returned to the content providers. For instance, a content provider 116 may determine the validity of the cached model output 166 in the matching cache entry 152 based upon when the model output 166 was generated. Therefore, the time when the model output 166 was generated may also be provided from the cache back to the content provider 116. Any other validity criteria can be provided as well.

The content providers 116, 118, 120 may each determine the validity of their corresponding model output 166, 168, 170 in different ways. For instance, one content provider 118 may compute a check sum over the model output 168 and any other validity criteria to see whether the model output 168 is valid. Another content provider 120 may determine the validity of the model output 170 based upon whether the query that generated the model output 170 is still valid. Checking the validity of the model output by computing a check sum is indicated by block 224. Checking the validity of the model output based on the validity of the query that spawned the model output is indicated by block 226. The validity of the model outputs can be checked in other ways as well, as indicated by block 228.

If a content provider 116, 118, and/or 120 determines that its model output 166, 168, and/or 170 is no longer valid, then that particular content provider re-runs given the query 106 to obtain a valid model output. Re-running the model to obtain a valid model output is indicated by block 230 in the flow diagram of FIG. 2. However, if a content provider 116, 118, and/or 120 determines that its model output 166, 168, and/or 170 retrieved from cache is still valid, then that model output is simply passed on to response orchestrator 124, without needing to re-run the AI model 166, 168, 170 corresponding to that content provider. Providing the model outputs (valid model outputs from cache or from re-running the content providers) to orchestrator 124 is indicated by block 214 and, again, running the response orchestrator to generate the final output (or response) 112 is indicated by block 216.

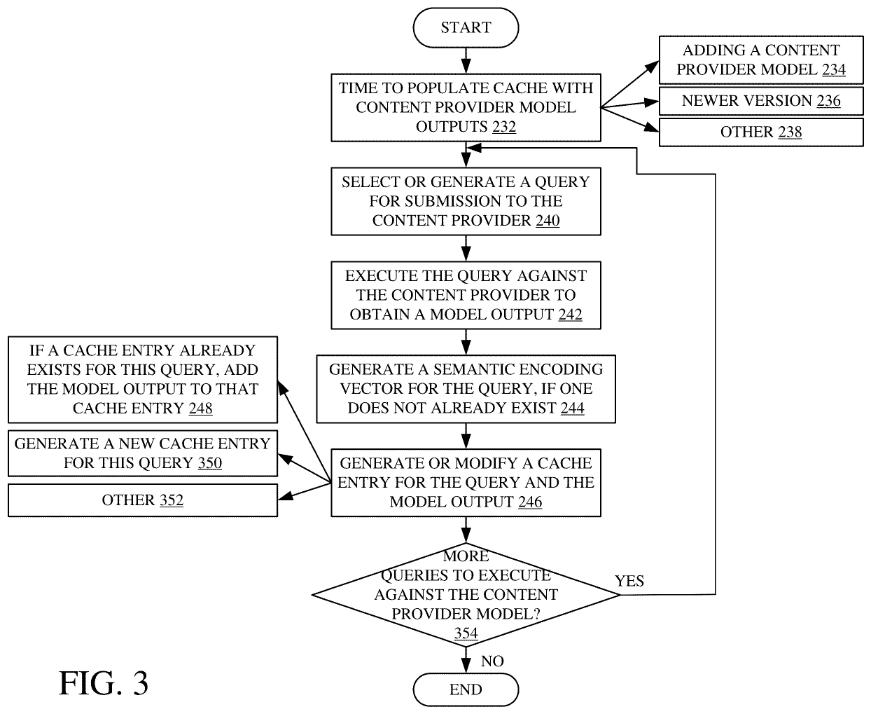

FIG. 3 is a flow diagram showing one example of how cache system 122 can populate cache store 134 with cache entries for a content provider, such as when a new content provider is added to generative AI system 110, when a newer version or upgraded version of an existing content provider is introduced in generative AI system 110, or for other reasons. Cache entry generator 148 first determines that the conditions are present for cache entry generator 148 to populate cache store 134 with one or more model outputs from a content provider, as indicated by block 232 in the flow diagram of FIG. 3. As discussed above, this may be when a new content provider is being added to generative AI system 110 and cache entry generator 148 is to seed cache store 134 with model outputs corresponding to the new content provider. Determining that cache store 134 is to be populated with new cache entries or new model outputs for existing cache entries because a new content provider or AI model is added to generative AI system 110 is indicated by block 234 in the flow diagram of FIG. 3. Determining that cache store 134 is to be populated with new cache entries or new model outputs for existing cache entries because a newer version of one of the content providers has been introduced into generative AI system 110 is indicated by block 236 in the flow diagram of FIG. 3. Of course, cache entry generator 148 may determine that a cache entry or model output is to be generated for other reasons as well, as indicated by block 238.

Cache entry generator 148 then selects or generates a query for submission to the content provider, as indicated by block 240 in the flow diagram of FIG. 3. The query may be a synthetically generated query, or a historical query that can be retrieved from a data store, the queries represented by the key values in cache entries 152-156, or other queries.

In one example, for instance, cache entry generator 148 selects cache entry 152 so that the new content provider can generate a model output that can be added to the content portion 162 of cache entry 152 for the query represented by query vector 164. In that case, cache entry generator 148 provides the textual query stored along side query vector 164 to the new content provider that is being added to generative AI system 110. In another example, cache entry generator 148 generates a new query, or selects a query in another way, where the query is not already represented in cache store 134. Selecting or generating a query for submission to the new content provider is indicated by block 240 in the flow diagram of FIG. 3. The new content provider then runs on the query to obtain a model output for that query, as indicated by block 242 in the flow diagram of FIG. 3.

If a new query was selected or generated, then semantic encoder 130 generates a semantic encoding vector for that query, if one has not already been generated, as indicated by block 244. Cache entry generator 148 then generates a new cache entry or modifies an existing cache entry for this query based upon the model output generated by the new content provider, as indicated by block 246 in the flow diagram of FIG. 3.

For instance, if a cache entry already exists for this query, then the model output from the new content provider is added to that cache entry, as indicated by block 248 in the flow diagram of FIG. 3. If no cache entry has yet been generated for this query, then a new cache entry is generated for this query, as indicated by block 350, in which the query can be run in the other content providers, to obtain model outputs from those content providers, as well. Then, the new cache entry is generated with the sematic representation of the query as the key value and all the model outputs as the content portion. The cache entry can be generated or modified in other ways as well, as indicated by block 352 in the flow diagram of FIG. 3.

If cache entry generator 148 is to generate a cache entry for more queries, as determined at block 354, then processing reverts to block 240 where the next query is selected. For instance, it may be that cache store 134 is being populated with cache entries for a new content provider. In that case, cache entry generator 148 can select each of the cache entries, identify the query associated with the selected cache entry, and have the new content provider run on that query to generate a model output for the corresponding cache entry. Thus, cache entry generator 148 can select the queries corresponding to each of the cache entries 152-156, or a subset of the queries, etc. The new model outputs (generated by the new content provider) are then added to each cache entry.

It can thus be seen that the present description describes a system which caches the model outputs of the individual content providers in a generative AI system. Therefore, even if one or more of the model outputs is invalid, the query need not necessarily be run against all of the content providers. Instead, any valid model outputs in the cache entry can still be used and the query can be re-run against only the content provider(s) whose model output is invalid. This drastically reduces the amount of GPU processing resources that are needed and greatly improves the benefits obtained by the cache system. Further, the present description describes an example in which a semantic encoder generates a semantic representation of the query so that inexact query matches can be identified where the queries are not exactly the same but where the semantic meaning of the queries is sufficiently similar that a match is identified. This also greatly enhances the efficiency with which the cache system operates, thus greatly reducing the computing system resources needed for the generative AI system to generate a response to a query.

It will be noted that the above discussion has described a variety of different systems, components, encoders, models, content providers, orchestrators, and/or logic. It will be appreciated that such systems, components, encoders, models, content providers, orchestrators, and/or logic can be comprised of hardware items (such as processors and associated memory, or other processing components, some of which are described below) that perform the functions associated with those systems, components, encoders, models, content providers, orchestrators, and/or logic. In addition, the systems, components, encoders, models, content providers, orchestrators, and/or logic can be comprised of software that is loaded into a memory and is subsequently executed by a processor or server, or other computing component, as described below. The systems, components, encoders, models, content providers, orchestrators, and/or logic can also be comprised of different combinations of hardware, software, firmware, etc., some examples of which are described below. These are only some examples of different structures that can be used to form the systems, components, encoders, models, content providers, orchestrators, and/or logic described above. Other structures can be used as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

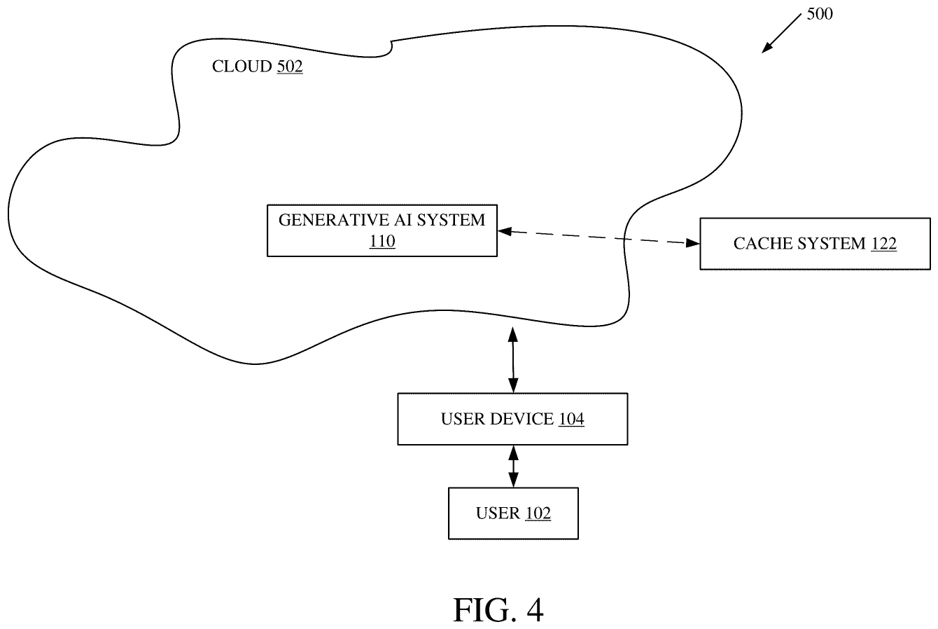

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, the components and functions can be provided from a server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 4, some items are similar to those shown in FIG. 1 and they are similarly numbered. FIG. 4 specifically shows that generative AI system 110 can be located in cloud 502 (which can be public, private, or a combination where portions are public while others are private). Therefore, user 102 uses a user device 104 to access those systems through cloud 502.

FIG. 4 also depicts another example of a cloud architecture. FIG. 4 shows that it is also contemplated that some elements of computing architecture 100 can be disposed in cloud 502 while others are not. By way of example, cache system 122 can be disposed outside of cloud 502, and accessed through cloud 502. Regardless of where the items are located, the items can be accessed directly by device 104, through a network (either a wide area network or a local area network), the items can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

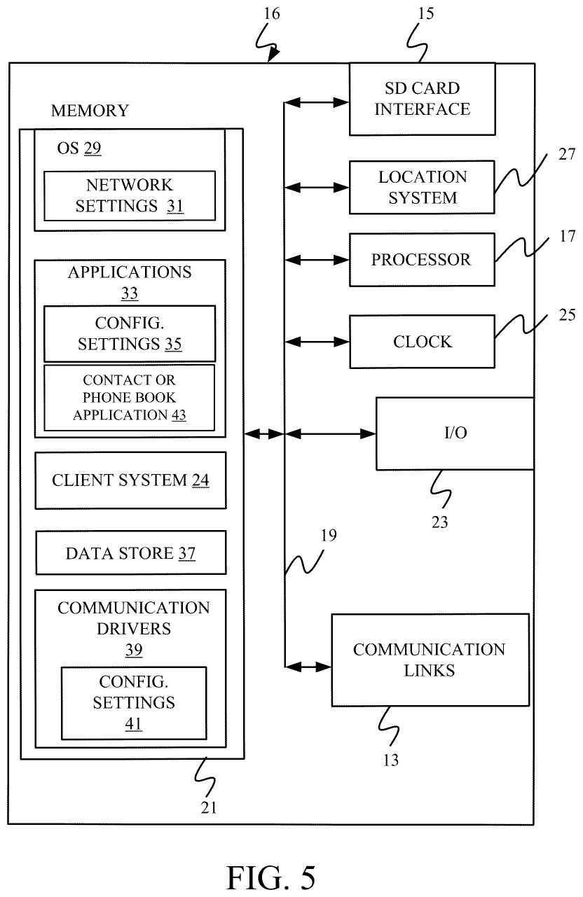

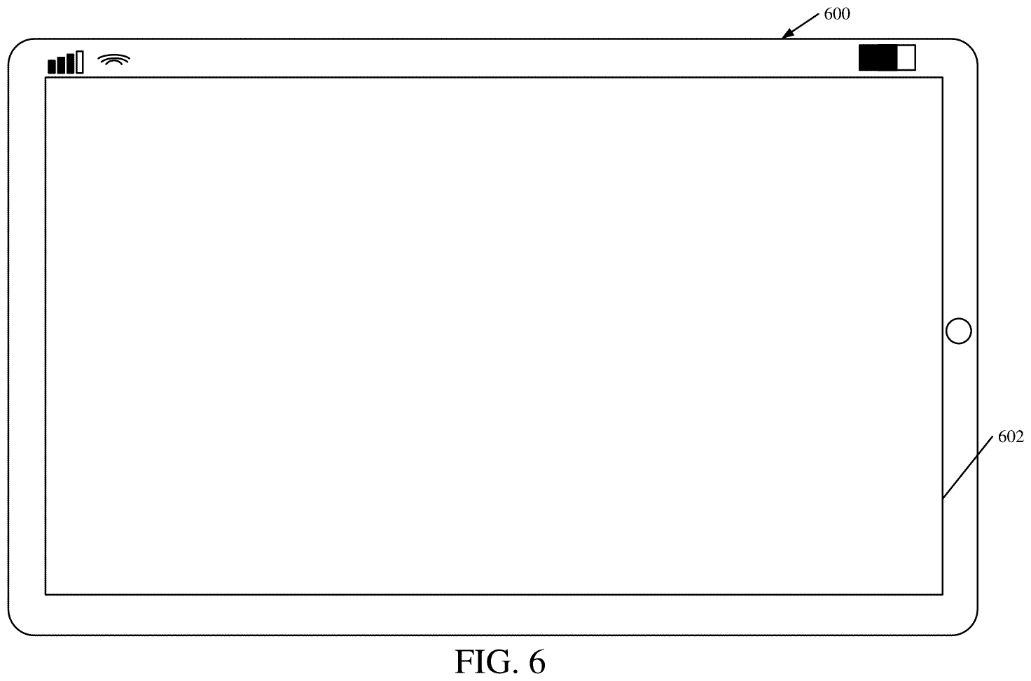

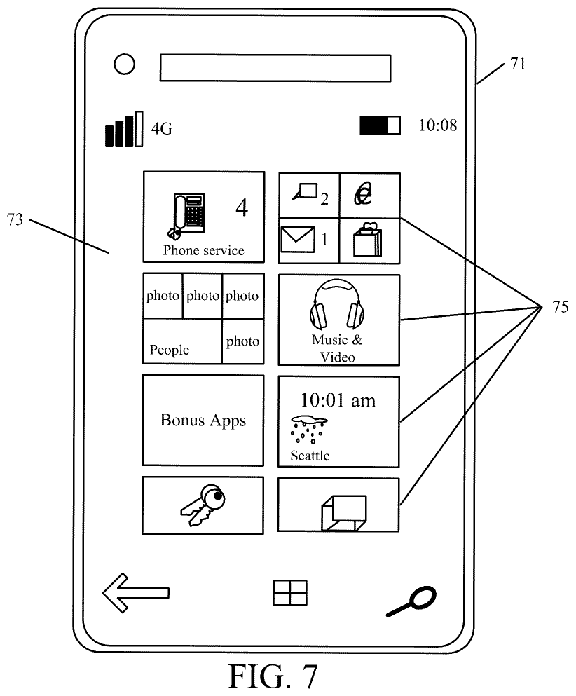

FIG. 5 is a simplified block diagram of one illustrative example of a handheld or mobile computing device that can be used as a user's or client's handheld device 16, in which the present system (or parts of it) can be deployed. FIGS. 6-7 are examples of handheld or mobile devices.

FIG. 5 provides a general block diagram of the components of a client device 16 that can run components of architecture 100 or user device 104 or that interacts with architecture 100, or both. In the device 16, a communications link 13 is provided that allows the handheld device to communicate with other computing devices and under some examples provide a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. Clock 25 can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one example in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 7 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

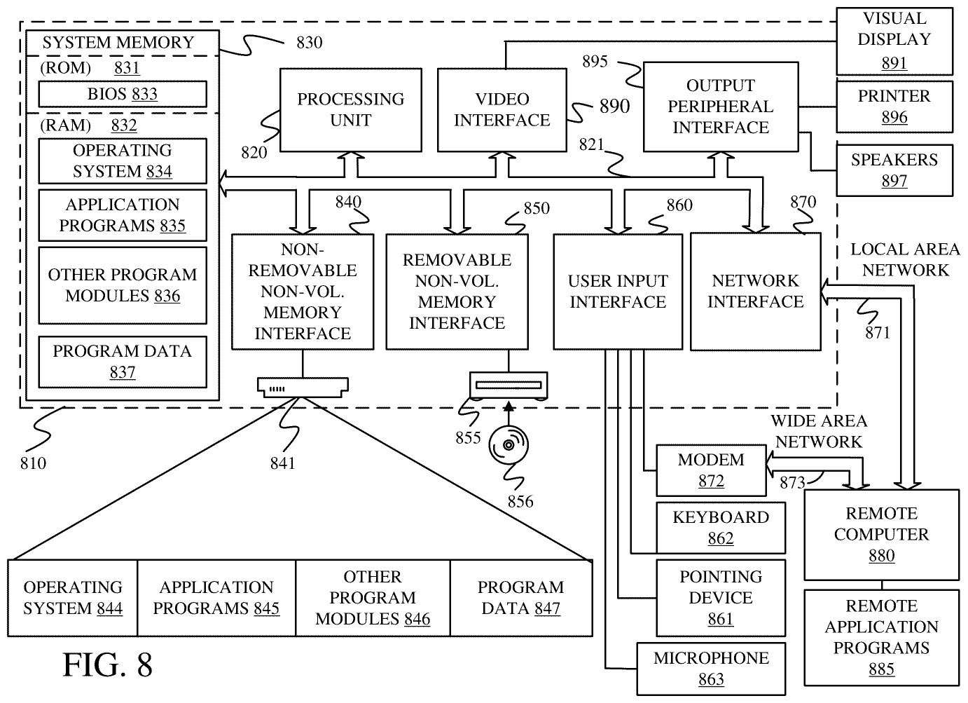

FIG. 8 is one example of a computing environment in which architecture 100, or parts of it, (for example) can be deployed. With reference to FIG. 8, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer implemented method, comprising:
receiving an input query at an artificial intelligence (AI) system, the AI system having a first content provider and a second content provider;
searching a cache store, based on the input query, for a matching cache entry;
extracting, from the matching cache entry, a first model output generated by the first content provider and a second model output generated by the second content provider;
providing the first model output and the input query to the first content provider;
providing the second model output and the input query to the second content provider; and
generating a response to the input query from the AI system based on the first model output and the second model output.

Example 2 is the computer implemented method of any or all previous examples wherein generating a response comprises:
validating the first model output with the first content provider to obtain a first validated model output; and
providing the first validated model output to a response orchestrator.

Example 3 is the computer implemented method of any or all previous examples wherein generating a response comprises:
validating the second model output with the second content provider to obtain a second validated model output; and
providing the second validated model output to the response orchestrator.

Example 4 is the computer implemented method of any or all previous examples wherein generating a response comprises:
selecting from the first validated model output and the second validated model output, using the response orchestrator, to generate the response.

Example 5 is the computer implemented method of any or all previous examples and further comprising:
generating a first cache entry, the first cache entry in the cache store comprising a first key value indicative of a semantic representation of a first cached query, the first cache entry further comprising first cache entry content including a first model output generated by the first content provider for the first cached query and a second model output generated by the second content provider for the first cached query; and
generating a second cache entry, the second cache entry in the cache store comprising a second key value indicative of a semantic representation of a second cached query, the second cache entry further comprising second cache entry content including a first model output generated by the first content provider for the second cached query and a second model output generated by the second content provider for the second cached query.

Example 6 is the computer implemented method of any or all previous examples wherein searching the cache store comprises:
generating a semantic representation of the input query; and
comparing the semantic representation of the input query to the first key value in the first cache entry and the second key value in the second cache entry to identify a closest cache entry.

Example 7 is the computer implemented method of any or all previous examples wherein first key value comprises a first vector and wherein the second key value comprises a second vector and wherein generating a semantic representation of the input query comprises:
generating an input vector corresponding to the input query.

Example 8 is the computer implemented method of any or all previous examples wherein comparing the semantic representation of the input query to the first key value in the first cache entry and the second key value in the second cache entry comprises:
measuring a first distance between the input vector and the first vector; and
measuring a second distance between the input vector and the second vector.

Example 9 is the computer implemented method of any or all previous examples wherein comparing the semantic representation of the input query to the first key value in the first cache entry and the second key value in the second cache entry comprises:
identifying a closest cache entry based on the shortest distance, of the first distance and the second distance; and
comparing the shortest distance to a distance threshold to determine whether the shortest distance meets the distance threshold.

Example 10 is the computer implemented method of any or all previous examples and further comprising:
if the shortest distance meets the distance threshold, then identifying the closest cache entry as the matching cache entry.

Example 11 is a computer implemented method, comprising:
receiving a first input query at an artificial intelligence (AI) system, the AI system having a first content provider and a second content provider;
generating a first model output with the first content provider based on the first input query;
generating a second model output with the second content provider based on the first input query; and
generating a first cache entry in a cache store corresponding to the first input query, the first cache entry including a first key value generated based on the first input query, and a first content portion including the first model output and the second model output.

Example 12 is the computer implemented method of any or all previous examples wherein generating the first cache entry comprises:
generating, as the first key value, a semantic representation of the first input query.

Example 13 is the computer implemented method of any or all previous examples and further comprising:
receiving second input query;
searching the cache store, based on the second input query;
identifying the first cache entry as a matching cache entry;
extracting, from the matching cache entry, the first model output generated by the first content provider and the second model output generated by the second content provider;
providing the first model output and the second input query to the first content provider;
providing the second model output and the second input query to the second content provider; and
generating a response to the second input query from the AI system based on the first model output and the second model output.

Example 14 is the computer implemented method of any or all previous examples wherein generating a response comprises:
validating the first model output with the first content provider to obtain a first validated model output; and
providing the first validated model output to a response orchestrator.

Example 15 is the computer implemented method of any or all previous examples wherein generating a response comprises:
validating the second model output with the second content provider to obtain a second validated model output; and
providing the second validated model output to the response orchestrator.

Example 16 is the computer implemented method of any or all previous examples wherein generating a response comprises:
selecting from the first validated model output and the second validated model output, using the response orchestrator, to generate the response.

Example 17 is the computer implemented method of any or all previous examples wherein the cache store has a plurality of cache entries, each cache entry having a key value and a content portion and wherein searching the cache store comprises:
generating a semantic representation of the second input query; and
comparing the semantic representation of the second input query to the key value corresponding to each cache entry to identify a closest cache entry.

Example 18 is an artificial intelligence (AI) computing system, comprising:
a plurality of different AI models each configured to generate a different model output based on a first input query;
a response generator configured to receive the different model output generated by each of the plurality of different AI models and generate a response based on the different model outputs; and
a cache generator configured to generate a cache entry corresponding to the first input query, the cache entry including the different model output generated by each of the plurality of different AI models.

Example 19 is the AI computing system of any or all previous examples wherein the cache generator comprises:
a semantic encoder configured to generate a semantic representation of the first input query and to generate, as part of the cache entry, the semantic representation of the first input query.

Example 20 is the AI computing system of any or all previous examples wherein the semantic encoder is configured to receive a second input query and generate a semantic representation of the second input query, and further comprising:
a search system configured to compare the semantic representation of the second input query with the semantic representation of the first input query in the cache entry to identify a matching cache entry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
receiving an input query at an artificial intelligence (AI) system, the AI system having a first content provider and a second content provider;
searching a cache store, based on the input query, for a matching cache entry;
extracting, from the matching cache entry, a first model output generated by the first content provider and a second model output generated by the second content provider;
providing the first model output and the input query to the first content provider;
providing the second model output and the input query to the second content provider; and
generating a response to the input query from the AI system based on the first model output and the second model output.

2. The computer implemented method of claim 1 wherein generating a response comprises:
validating the first model output with the first content provider to obtain a first validated model output; and
providing the first validated model output to a response orchestrator.

3. The computer implemented method of claim 2 wherein generating a response comprises:
validating the second model output with the second content provider to obtain a second validated model output; and
providing the second validated model output to the response orchestrator.

4. The computer implemented method of claim 3 wherein generating a response comprises:
selecting from the first validated model output and the second validated model output, using the response orchestrator, to generate the response.

5. The computer implemented method of claim 1 and further comprising:
generating a first cache entry, the first cache entry in the cache store comprising a first key value indicative of a semantic representation of a first cached query, the first cache entry further comprising first cache entry content including a first model output generated by the first content provider for the first cached query and a second model output generated by the second content provider for the first cached query; and
generating a second cache entry, the second cache entry in the cache store comprising a second key value indicative of a semantic representation of a second cached query, the second cache entry further comprising second cache entry content including a first model output generated by the first content provider for the second cached query and a second model output generated by the second content provider for the second cached query.

6. The computer implemented method of claim 5 wherein searching the cache store comprises:
generating a semantic representation of the input query; and
comparing the semantic representation of the input query to the first key value in the first cache entry and the second key value in the second cache entry to identify a closest cache entry.

7. The computer implemented method of claim 6 wherein first key value comprises a first vector and wherein the second key value comprises a second vector and wherein generating a semantic representation of the input query comprises:
generating an input vector corresponding to the input query.

8. The computer implemented method of claim 7 wherein comparing the semantic representation of the input query to the first key value in the first cache entry and the second key value in the second cache entry comprises:
measuring a first distance between the input vector and the first vector; and
measuring a second distance between the input vector and the second vector.

9. The computer implemented method of claim 8 wherein comparing the semantic representation of the input query to the first key value in the first cache entry and the second key value in the second cache entry comprises:
identifying a closest cache entry based on the shortest distance, of the first distance and the second distance; and
comparing the shortest distance to a distance threshold to determine whether the shortest distance meets the distance threshold.

10. The computer implemented method of claim 9 and further comprising:
if the shortest distance meets the distance threshold, then identifying the closest cache entry as the matching cache entry.

11. A computer implemented method, comprising:
receiving a first input query at an artificial intelligence (AI) system, the AI system having a first content provider and a second content provider;
generating a first model output with the first content provider based on the first input query;
generating a second model output with the second content provider based on the first input query; and
generating a first cache entry in a cache store corresponding to the first input query, the first cache entry including a first key value generated based on the first input query, and a first content portion including the first model output and the second model output.

12. The computer implemented method of claim 11 wherein generating the first cache entry comprises:
generating, as the first key value, a semantic representation of the first input query.

13. The computer implemented method of claim 12 and further comprising:
receiving second input query;
searching the cache store, based on the second input query;
identifying the first cache entry as a matching cache entry;
extracting, from the matching cache entry, the first model output generated by the first content provider and the second model output generated by the second content provider;
providing the first model output and the second input query to the first content provider;
providing the second model output and the second input query to the second content provider; and
generating a response to the second input query from the AI system based on the first model output and the second model output.

14. The computer implemented method of claim 13 wherein generating a response comprises:
validating the first model output with the first content provider to obtain a first validated model output; and
providing the first validated model output to a response orchestrator.

15. The computer implemented method of claim 14 wherein generating a response comprises:
validating the second model output with the second content provider to obtain a second validated model output; and
providing the second validated model output to the response orchestrator.

16. The computer implemented method of claim 15 wherein generating a response comprises:
selecting from the first validated model output and the second validated model output, using the response orchestrator, to generate the response.

17. The computer implemented method of claim 16 wherein the cache store has a plurality of cache entries, each cache entry having a key value and a content portion and wherein searching the cache store comprises:
generating a semantic representation of the second input query; and
comparing the semantic representation of the second input query to the key value corresponding to each cache entry to identify a closest cache entry.

18. An artificial intelligence (AI) computing system, comprising:
a plurality of different AI models each configured to generate a different model output based on a first input query;
a response generator configured to receive the different model output generated by each of the plurality of different AI models and generate a response based on the different model outputs; and
a cache generator configured to generate a cache entry corresponding to the first input query, the cache entry including the different model output generated by each of the plurality of different AI models.

19. The AI computing system of claim 18 wherein the cache generator comprises:
a semantic encoder configured to generate a semantic representation of the first input query and to generate, as part of the cache entry, the semantic representation of the first input query.

20. The AI computing system of claim 19 wherein the semantic encoder is configured to receive a second input query and generate a semantic representation of the second input query, and further comprising:
a search system configured to compare the semantic representation of the second input query with the semantic representation of the first input query in the cache entry to identify a matching cache entry.
